(19) United States
(12) Patent Application Publication
(10) Pub. No.: US 2014/0307323 A1
(43) Pub. Date: Oct. 16, 2014

(54) OPTICAL LENS AND APPARATUS FOR PRODUCING UNIFORM BEAM USING SAME

(71) Applicant: ELECTRONICS AND TELECOMMUNICATIONS RESEARCH INSTITUTE, Daejeon (KR)

(72) Inventor: Won Hui LEE, Daejeon (KR)

(73) Assignee: ELECTRONICS AND TELECOMMUNICATIONS RESEARCH INSTITUTE, Daejeon (KR)

(21) Appl. No.: 14/022,688

(22) Filed: Sep. 10, 2013

(30) Foreign Application Priority Data
Apr. 16, 2013 (KR) 10-2013-0041815

(51) Int. Cl. G02B 27/09; G02B 3/00; G02B 3/06

(52) U.S. Cl. CPC G02B 27/0927; G02B 3/06; G02B 3/0062
USPC 359/619; 359/718; 359/711

(57) ABSTRACT

An optical lens for converting an incident beam with an irregular brightness into a uniform beam with a regular brightness includes an adjustable component configured to adjust a brightness distribution or magnitude distribution of a portion with a relatively high brightness in the incident beam. The optical lens includes a lens surface configured to refract the remaining portion in the incident beam except the portion with a relatively high brightness distribution to irradiate a target.

### RELATED APPLICATIONS

This application claims the benefit of Korean Patent Application No. 10-2013-0041815, filed on Apr. 16, 2013, which is hereby incorporated by reference as if fully set forth herein.

### FIELD OF THE INVENTION

The present invention relates to an optical lens to produce uniform beams, and more particularly, to an optical lens having an adjustable component to adjust the beam portion with high brightness or magnitude distribution in an incident beam having irregular brightness when the incident beam enter and an apparatus for producing uniform beams using the same.

### BACKGROUND OF THE INVENTION

Generally, optical sources and electromagnetic wave sources have a shape of a Gaussian beam rather than a uniform beam. For the Gaussian beam, it has the strongest peak field and brightness at its center portion and thus irradiates only an extremely small part of a target object corresponding to the center portion. Therefore, in order to obtain an image of a large object using the Gaussian beam, it is required to scan every point in the image and combine all the points, thereby acquiring the full image. This method is able to acquire the image of the object, but it has a drawback in that it takes much time to scan and combine the image.

Proposed is a method using a focus lens and an array lens to complement such a drawback. Specifically, the array lens that is placed in front of the focus lens makes incident beams to disperse into partial beams. These partial beams are combined at a focal plane and then are divided again to irradiate a target. Thus, the entire beam that irradiate the target takes the shape of a broad and uniform beam.

However, in such a method, a uniform beam is irradiated to the target, but the use of multiple lenses makes it difficult to fabricate and optimize an optical system.

### SUMMARY OF THE INVENTION

In view of the above, the present invention provides an optical lens having an adjustable component capable of adjusting the beam portion with high brightness or magnitude distribution in an incident beam having irregular brightness when the incident beam enter and an apparatus for producing uniform beams using the same.

Further, the present invention provides an apparatus for producing a uniform beam, adapted to divide an incident beam having irregular brightness into a plurality of partial beams and adjust the beam portions with relatively high brightness or magnitude distribution in the partial beams relatively high brightness through the use of the adjustable component to convert into the uniform beam.

In accordance with an embodiment of the present invention, there is provided an optical lens for converting an incident beam with an irregular brightness into a uniform beam with a regular brightness, which includes: an adjustable component configured to adjust a brightness distribution or magnitude distribution of a portion with a relatively high brightness in the incident beam; and a lens surface configured to refract the remaining portion in the incident beam except the portion with a relatively high brightness distribution to irradiate a target.

In the exemplary embodiment, the lens surface has a convex shape and comprises an incident surface on which the remaining portions in the incident beam enter.

In the exemplary embodiment, the lens surface includes: an incident surface on which the remaining portions of the incident beam enter; and an irradiation surface configured to irradiate the beam refracted by the incident surface, wherein the incident surface and the irradiation surface have a convex shape.

In the exemplary embodiment, the optical lens has a shape of a toroid with a hole, the adjustable component comprising the hole.

In the exemplary embodiment, the lens surface has an incident surface, the incident surface having a shape of a polyhedron curved surface which is different in degrees of inclination depending on the brightness distribution of the incident beam.

In the exemplary embodiment, the optical lens has a shape of a polygon with the adjustable component in a region on which a central portion of the incident beam enters.

In the exemplary embodiment, the incident beam has a Gaussian distribution which has a high brightness in its central portion.

In accordance with another exemplary embodiment of the present invention, there is provided for an apparatus for producing a uniform beam, which includes: an array lens on which an incident beam enters, the incident beam having a higher brightness in its central portion than in the remaining portions of the incident beam, and disperse the incident beam into a plurality of partial beams; and a plurality of optical lenses, the optical lenses being configured to convert the dispersed partial beams into uniform beams, wherein each of the optical lenses includes: an adjustable component configured to admit a central portion of the partial beams and disperse the brightness distribution of the central portion of the partial beams; and a lens surface configured to refract the remaining portions of the partial beams to irradiate a target.

In the exemplary embodiment, the lens surface includes: an incident surface on which the remaining portions of the incident beam enter; and an irradiation surface configured to irradiate the beams refracted by the incident surface, wherein the incident surface and the irradiation surface have a convex shape.

In the exemplary embodiment, each of the optical lenses has a shape of a toroid with a hole, the adjustable component comprising the hole.

In the exemplary embodiment, the lens surface has an incident surface, the incident surface having a shape of polyhedron curved surface which is different in degrees of inclination depending on the brightness distribution of the incident beam.

In the exemplary embodiment, the optical lens has a shape of a polygon with the adjustable component in a region on which a central portion of the incident beam enters.

In the exemplary embodiment, the incident beam has a Gaussian distribution which has a high brightness in its central portion.

As set forth above, the embodiment of the present invention provides an optical lens capable of converting a Gaussian beam into a uniform beam, which has a simpler structure than a conventional compound lens to acquire the uniform beam. Therefore, when an imaging system is configured using the optical lens, it is possible to irradiate a target widely with a uniform brightness distribution, thereby achieving an image detection in real time and obtaining a clear image through the use of the uniform beam.

Also, when configuring the optical lenses in the form of an array, the optical lenses in the form of an array may be used in various kinds of devices that need a uniform source with wide surface.

### BRIEF DESCRIPTION OF THE DRAWINGS

The above and other objects and features of the present invention will become apparent from the following description of the embodiments given in conjunction with the accompanying drawings, in which:

FIG. 1 shows a configuration of an optical lens in accordance with an embodiment of the present invention;

FIG. 2 shows a configuration of an optical lens in accordance with another embodiment of the present invention;

FIG. 3 is a diagram explaining the operation principle of an optical lens in accordance with an embodiment of the present invention;

FIG. 4 illustrates a characteristic of a Gaussian beam simulated using an optical tool;

FIG. 5 illustrates a characteristic of a uniform beam obtained from an inventive optical lens simulated using an optical tool;

FIG. 6 is an exemplary diagram in which the inventive optical lenses are arranged in the form of an array in accordance with an embodiment of the present invention; and

FIG. 7 shows an apparatus for producing a uniform beam using the optical lenses in accordance with an embodiment of the present invention.

### DETAILED DESCRIPTION OF THE EMBODIMENTS

The advantages and features of exemplary embodiments of the present invention and methods of accomplishing them will be clearly understood from the following description of the embodiments taken in conjunction with the accompanying drawings. However, the present invention is not limited to those embodiments and may be implemented in various forms. It should be noted that the embodiments are provided to make a full disclosure and also to allow those skilled in the art to know the full scope of the present invention. Therefore, the present invention will be defined only by the scope of the appended claims.

In the following description, well-known functions or constitutions will not be described in detail if they would unnecessarily obscure the embodiments of the invention. Further, the terminologies to be described below are defined in consideration of functions in the invention and may vary depending on a user's or operator's intention or practice. Accordingly, the definition may be made on a basis of the content throughout the specification.

Hereinafter, the embodiments of the present invention will be described in detail with reference to the accompanying drawings.

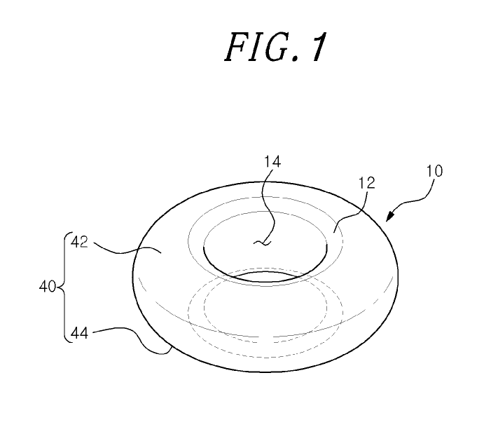

FIG. 1 shows a configuration of an optical lens in accordance with an embodiment of the present invention. An optical lens 10 may have generally the shape of a toroid and includes an adjustable component 14 located in a region that a beam portion with a relative high brightness distribution in an incident beam enter, e.g., a center region 20 and a lens surface 40 on which the remaining beam portions of the incident beam enter to irradiate a target (not shown). The adjustable component 14 has a type of a hole, and a peripheral edge 12 of the hole 14 enables the dispersion of the beam portion with the relative high brightness or field distribution.

The lens surface 40 is composed of an incident surface 42 that the remaining beam portions of the incident beam enter and an irradiation surface 44 that directs the beam that is refracted from the incident surface 42 to irradiate the target.

Both the incident surface 42 and the irradiation surface 44 may have a convex rounded shape in common or may have a shape of a polyhedron curved surface which is different in degrees of inclination depending on the brightness distribution of the incident beam.

As described above, the incident surface 42 and the irradiation surface 44 have the convex shape and hence the optical lens 10 of an exemplary embodiment of the present invention may be the shape of a toroid. Alternatively, for the incident surface 42 and the irradiation surface 44 having the convex shape, the optical lens 10 may have the shape of a polygon.

The incident beam that enters the optical lens 10 of FIG. 1 may have the shape of a Gaussian beam with irregular brightness. That is, the incident beam may have the shape of Gaussian beam in which a central portion has a high brightness distribution and both sides have a relatively low brightness distribution, which is also referred to as a Gaussian distribution.

Some of the central portion of the incident beam enters the hole 14 of the optical lens 10 and then pass through the hole 14, and the remainders of the incident beam are refracted on the incident surface 42 to irradiate the target.

Accordingly, the central portion with a strong field or brightness distribution in the incident beam is dispersed by the periphery edge 12 of the hole 14, which results in converting the incident beams into a uniform beam to irradiate the target.

Meanwhile, in accordance with the exemplary embodiment of the present invention, the size of the hole 14 may be determined depending on the strong field or brightness distribution of the incident beam. Alternatively, the optical lens may be made with free of the hole.

The lens surface 40 may be implemented with a variety of materials depending on the wavelength and the refractive index of the incident beam, and a description of the lens surface 40 will not be made because the materials are well known to those skilled in the art.

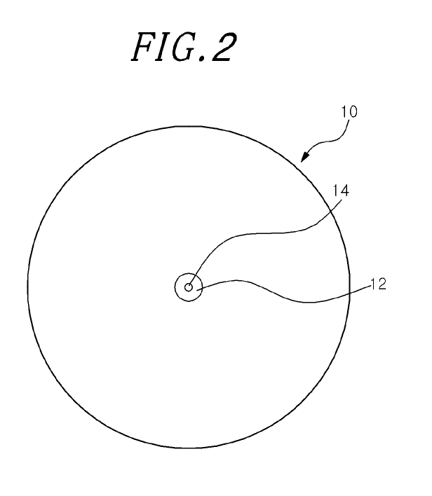

FIG. 2 shows a plan view of an optical lens in accordance with another embodiment of the present invention, wherein the optical lens 10 has a hole 14 which is equivalent to an adjustable component of which diameter is remarkably small.

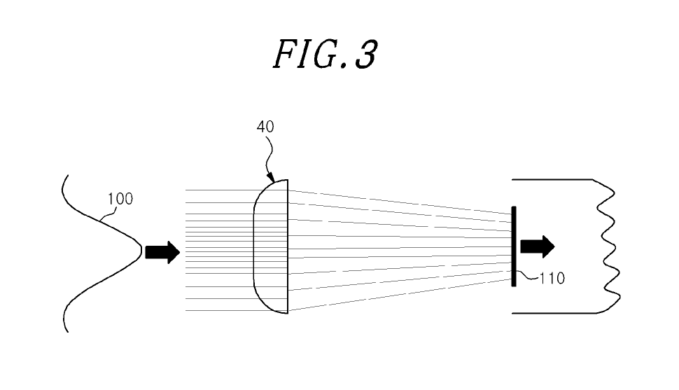

The operation principle of the optical lens shown in FIGS. 1 and 2 will be described with reference to FIG. 3.

FIG. 3 is a diagram explaining the operation principle of the optical lens 10 in accordance with the embodiment of the present invention.

As illustrated in FIG. 3, when an incident beam, which is a Gaussian beam 100, enters the optical lens 10, an extremely small part of a central portion with the highest brightness distribution or field distribution in the Gaussian beam 100 passes through the hole 14 of the optical lens 10. The remaining portions of the Gaussian beam 100 are refracted by the lens surface 40 to irradiate a target 110.

Moreover, the highest field or brightness distribution of the central portion of the Gaussian beam 100 is dispersed by the periphery edge 12 in the hole 14 and thus the field or brightness distribution of the Gaussian beam 100 becomes even when the incident beam irradiates the target 110. In other words, the Gaussian beam 100 is converted into the shape of a uniform beam by the optical lens 10 of the embodiment of the present invention, thereby entering the target 110.

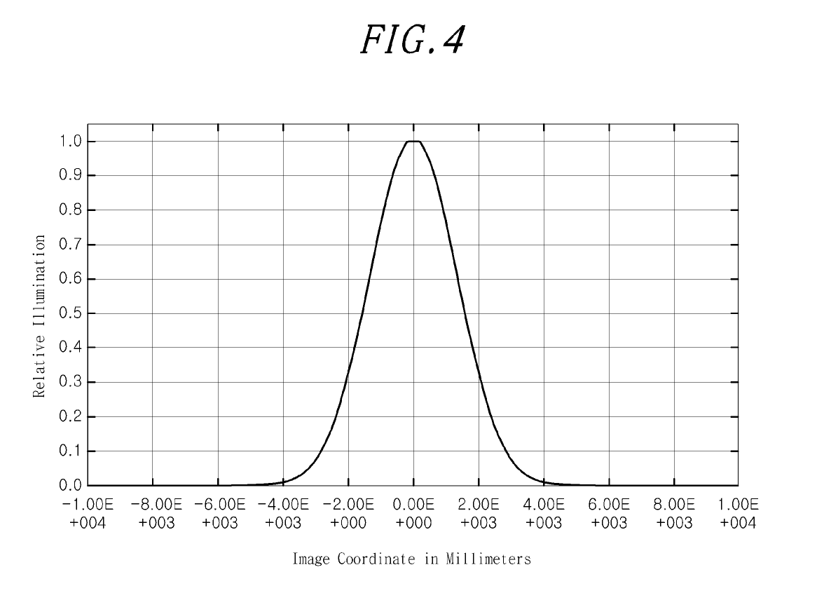

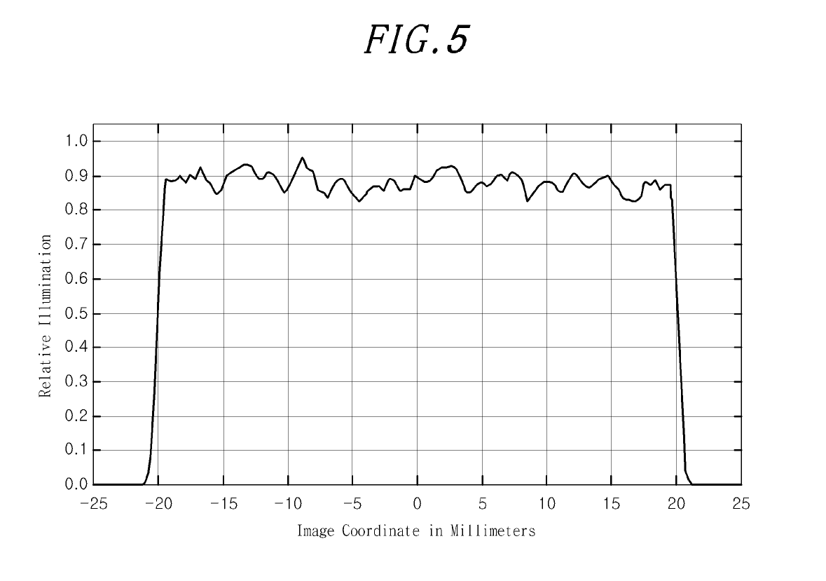

FIG. 5 illustrates the beam shape when the Gaussian beam having the brightness distribution depicted in FIG. 4 enters the optical lens 10 having the configuration as described above and then irradiates the target. It can be seen from the drawing that the shape of the Gaussian beam as depicted in FIG. 4 is changed into the shape of a uniform beam with a relatively flat and a wide band as shown in FIG. 5.

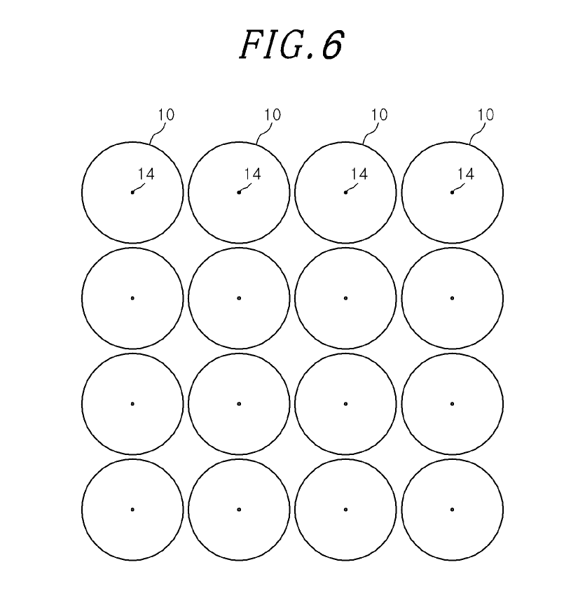

Following is a description of an example that applies the optical lens 10 in accordance with an exemplary embodiment of the present invention, which will be made with reference to FIG. 6.

FIG. 6 is an exemplary diagram in which the optical lenses 10 are arranged in the form of an array in accordance with an embodiment of the present invention.

As illustrated in FIG. 6, a structure in the form of an array may be employed in a multi-beam source or an electromagnetic wave source, and, for example, a plurality of the optical lenses 10 may be arranged in the form of an array.

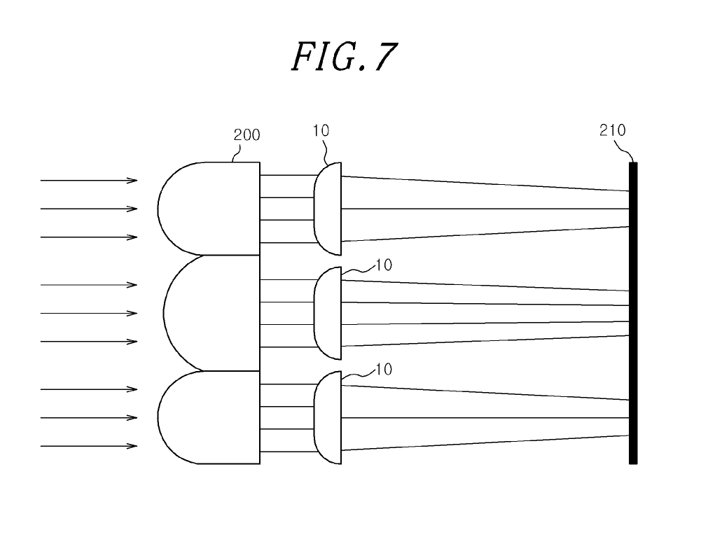

In accordance with the present invention, the optical lens 10 may be combined with a different kind of lens to configure an apparatus for producing a uniform beam, which will be described with reference to FIG. 7.

FIG. 7 shows an apparatus for producing a uniform beam that is configured by employing the optical lenses 10 in accordance with an embodiment of the present invention. As shown, the apparatus for producing a uniform beam includes plural optical lenses 10 and an array lens 200 that is disposed on the upstream of the optical lenses 10.

When an incident beam, in which a brightness distribution in a central portion is higher than that in the remaining portions of the incident beam, i.e., a Gaussian beam enters the uniform beam providing apparatus of FIG. 7, the lens array 200 makes the incident beam disperse in plural partial beams. Specifically, the array lens 200 disperses the Gaussian beam in a plurality of the partial beams and the partial beams then direct the optical lenses 10.

In this case, each of the partial beams may also have a higher brightness in its central portion as compared to other portions.

While the central portions of the partial beams pass through the adjustable component, i.e., the hole 14, a strong field or brightness distribution of each of the central portions is dispersed by the periphery edge 12 in the hole 14.

Consequently, each partial beam that is dispersed by the array lens 200 is changed into a uniform beam by the optical lenses 10 and irradiates a target 210.

While the description of the present invention has been made to the exemplary embodiments, various changes and modifications may be made without departing from the scope of the invention. Therefore, the scope of the present invention should be defined by the appended claims rather than by the foregoing embodiments.

What is claimed is:

1. An optical lens for converting an incident beam with an irregular brightness into a uniform beam with a regular brightness, the optical lens comprising:
an adjustable component configured to adjust a brightness distribution or magnitude distribution of a portion with a relatively high brightness in the incident beam; and
a lens surface configured to refract the remaining portion in the incident beam except the portion with a relatively high brightness distribution to irradiate a target.

2. The optical lens of claim 1, wherein the lens surface has a convex shape and comprises an incident surface on which the remaining portions in the incident beam enter.

3. The optical lens of claim 1, wherein the lens surface comprises:
an incident surface on which the remaining portions of the incident beam enter; and
an irradiation surface configured to irradiate the beam refracted by the incident surface,
wherein the incident surface and the irradiation surface have a convex shape.

4. The optical lens of claim 1, wherein the optical lens has a shape of a toroid with a hole, the adjustable component comprising the hole.

5. The optical lens of claim 1, wherein the lens surface has an incident surface, the incident surface having a shape of a polyhedron curved surface which is different in degrees of inclination depending on the brightness distribution of the incident beam.

6. The optical lens of claim 1, wherein the optical lens has a shape of a polygon with the adjustable component in a region on which a central portion of the incident beam enters.

7. The optical lens of claim 1, wherein the incident beam has a Gaussian distribution which has a high brightness in its central portion.

8. An apparatus for producing a uniform beam, the apparatus comprising:
an array lens on which an incident beam enters, the incident beam having a higher brightness in its central portion than in the remaining portions of the incident beam, and disperse the incident beam into a plurality of partial beams; and
a plurality of optical lenses, the optical lenses being configured to convert the dispersed partial beams into uniform beams,
wherein each of the optical lenses comprises:
an adjustable component configured to admit a central portion of the partial beams and disperse the brightness distribution of the central portion of the partial beams; and
a lens surface configured to refract the remaining portions of the partial beams to irradiate a target.

9. The apparatus of claim 8, wherein the lens surface comprises:
an incident surface on which the remaining portions of the incident beam enter; and
an irradiation surface configured to irradiate the beams refracted by the incident surface,
wherein the incident surface and the irradiation surface have a convex shape.

10. The apparatus of claim 8, wherein each of the optical lenses has a shape of a toroid with a hole, the adjustable component comprising the hole.

11. The apparatus of claim 8, wherein the lens surface has an incident surface, the incident surface having a shape of polyhedron curved surface which is different in degrees of inclination depending on the brightness distribution of the incident beam.

12. The apparatus of claim 8, wherein the optical lens has a shape of a polygon with the adjustable component in a region on which a central portion of the incident beam enters.

13. The apparatus of claim 8, wherein the incident beam has a Gaussian distribution which has a high brightness in its central portion.
